(19) United States
(12) Patent Application Publication
(10) Pub. No.: US 2023/0097312 A1
(43) Pub. Date: Mar. 30, 2023

(54) SYSTEM AND METHOD FOR NAVIGATING DASHBOARD CONTENT

(71) Applicant: Modern Market Technologies, Inc., Chula Vista, CA (US)

(72) Inventors: Jose FRAUSTO, Chula Vista, CA (US); Jose LUQUIN, Chula Vista, CA (US)

(21) Appl. No.: 17/953,642

(22) Filed: Sep. 27, 2022

Related U.S. Application Data
(60) Provisional application No. 63/248,946, filed on Sep. 27, 2021.

(51) Int. Cl. G06F 3/0482; G06F 3/04845; G06F 3/0487; G06F 3/02

(52) U.S. Cl. CPC G06F 3/0482; G06F 3/04845; G06F 3/0487; G06F 3/0227

(57) ABSTRACT

A system and method for displaying content by a computing device that includes a circular portion of a screen and an adjacent rectangular portion of a screen. Icons displayed in the circular portion are arranged in a ring around a center thereof. User input may cause the icons to revolve about the center. User-selection of an icon, which may involve the user revolving the icon to a home position, may cause summary content to be displayed at the center of the circular portion and detailed content to be displayed in the rectangular portion. The circular and rectangular portions may be portions of a same display screen or portions of different display screens. The circular portion may be disposed within a perimeter of a physically rotatable dial.

### FIELD

This disclosure relates to a system and method to enable a user to navigate through and/or interact with displayed content, and more particularly, to enable a user to navigate through and/or interact with displayed content concerning a renovation of a dwelling or dwelling construction project. Still more particularly, this disclosure relates to a system and method for displaying project-dashboard content on a rectangular portion of a screen corresponding to a user-selectable icon that is displayed on an adjacent circular portion of a screen.

### BACKGROUND

There may be a great deal of information to manage when undertaking a dwelling renovation or construction project. For example, a property owner may appreciate being able to rapidly access information related to many of the following: construction progress, construction costs, financing, property value, suggested upgrades, relevant news, relevant publications, and so on. Currently such information may be available in print or electronic form from; however, it may not be aggregated and presented in a unified manner, and it may not be updated and made available in real time to the property owner.

There are many dashboards and graphical user interfaces (GUIs) that organize information, present information to a user, and enable the user to navigate and interact with the information. Some dashboards and GUIs (hereafter simply “dashboards”) are implemented on a desktop computer or mobile device while others are implemented on custom computing hardware and/or devices. There are some applications, such as dwelling renovation or construction projects, where the user may not have the time, patience, or skill to learn how to navigate or interface with an unfamiliar dashboard. In such case, an interface that is modeled after a familiar device may enable the user to more naturally navigate and interact with dashboard content, thereby providing an improved user experience. For example, many smart thermostat interfaces are modeled after a familiar analog circular thermostat. See, e.g., U.S. Pat. No. 8,195,313. However, an oversimplified interface can make it difficult to navigate and interact with dense, rich, or voluminous content that may be available during a dwelling renovation or construction project, such as content concerning project management, financial reports, and news feeds.

The present invention solves one or more of the aforementioned problems in the prior art.

### SUMMARY

The several embodiments provide a system and method to enable a user to easily and rapidly navigate and interact with a dashboard of information related to a dwelling renovation or construction project. There are several objects of the several embodiments, including: providing a familiar control interface; enabling a user to naturally page through content using a familiar control interface; and displaying summary content and detailed content corresponding to a user-selected icon.

It is an object of some embodiments to provide a display method for a computing device that includes a circular portion of a screen and an adjacent rectangular portion of a screen. The computing device displays a plurality of icons within the circular portion near a perimeter thereof. In response to a user selecting a first icon, first summary content may be displayed near a center of the circular portion and first detailed content may be displayed in the rectangular portion. In response to the user selecting a second icon, second summary content may be displayed near the center of the circular portion and second detailed content may be displayed in the rectangular portion. An icon may be selected by any suitable means, for example via mouse point-and-click or via touchscreen contact. Further, an icon may be selected by mouse click(s) only, mouse click-and-drag, touchscreen touch(es) only, or touchscreen touch-and-drag. In some embodiments, the circular portion may be disposed concentrically within a rotatable dial, where an icon may be selected by physically rotating the dial.

Some embodiments provide a non-transitory computer-readable medium having instructions for causing a computing device to perform a method for displaying content. In some embodiments, the method includes:
displaying, adjacent to and within a perimeter of a circular portion of a display screen of the computing device, a plurality of icons each separated by an angular distance;
receiving a user selection of a first icon;
displaying, near a center of the circular portion, first summary content related to the first icon in response to receiving the user selection of the first icon;
displaying, within a rectangular portion of the display screen, first detailed content related to the first icon in response to receiving the user selection of the first icon;
receiving a user selection of a second icon;
displaying, near the center of the circular portion, second summary content related to the second icon in response to receiving the user selection of the second icon; and
displaying, within the rectangular portion, second detailed content related to the second icon in response to receiving the user selection of the second icon

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 shows a prior art television having a rectangular display screen and a round control dial.

FIG. 2A shows an embodiment implemented on a stationary computing device and FIG. 2B shows an embodiment implemented on a mobile computing device.

FIG. 3 shows an exemplary interface of an embodiment implemented on a computing device having one screen.

FIGS. 4A-4B show the exemplary interface of FIG. 3 where first and second icons have been selected, respectfully.

FIG. 5 shows an embodiment implemented on a computing device having a first screen on or within a dial and a second screen adjacent thereto.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions, or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise.

In this disclosure, the terms “renovation” and “construction” may be used interchangeably to describe a project related to improving, expanding, or building a residential dwelling. The terms “information” and “content” may be used interchangeably herein to describe data, text, figures, images, statistics, facts, records, notifications, communications, and so on. The terms “dial,” “knob,” and “wheel” may be used interchangeably herein to describe a physically or virtually rotatable control element. Terms “circular” and “round” may be used interchangeably to describe an element whose perimeter is composed of more curved edges than straight edges. The term “rectangular” may be used to describe an element whose shape is composed of more straight edges than curved edges. The term “adjacent” means next-to or near-by, where adjacent objects may be separated by a distance and/or separated by intervening objects. A “stationary computing device” is a computing device that is generally not carried by a user during use, such as a desktop or laptop computer. A “mobile device” is a computing device that may be readily carried by a user during use, such as a mobile phone or a tablet. A “user” may be any person who uses the system and method described herein, for example a property owner, a customer, a contractor, a service provider, and so on.

The following numerals are used to describe various features of the embodiments.
10 computing device
20 screen
20a first screen
20b second screen
100 circular portion
110 perimeter
120 center
130 icon
130a first icon
130b second icon
140 angular distance
150 home position
160 rectangular portion
170 summary content
170a first summary content
170b second summary content
180 detailed content
180a first detailed content
180b second detailed content
200 mouse
202 cursor
210 touch device
220 dial
230 keyboard
240 toggle button

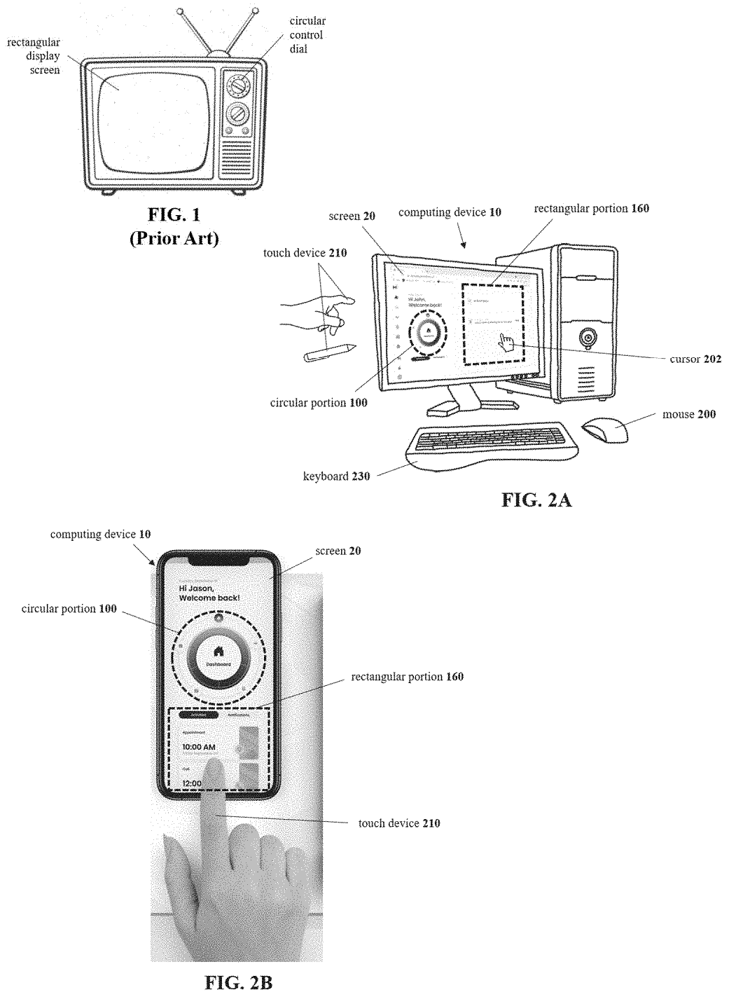

FIG. 1 shows a prior art television comprising a substantially rectangular display screen adjacent to a round, or circular, control dial. A user may rotate the dial to select a channel. This is an example of a familiar interface that enables a user to rapidly navigate through various channels.

FIG. 2A shows an embodiment of a system and method for displaying dashboard content that is loosely modelled after a familiar early television as shown in FIG. 1, which comprises a computing device 10, such as a computer or laptop, having a screen 20 capable of displaying a graphical user interface. The screen 20 comprises a circular portion 100 and a rectangular portion 160. A user may provide input to the computing device 10 via any suitable instrument, including a mouse 200, a keyboard 230, and a touch device 210 (such as a finger or stylus). A cursor 202 may be displayed on the screen 20 to indicate a previous, current, future, or potential input location on the screen 20. The screen 20 may be a touchscreen capable of accepting touch input at any location, for example within the circular portion 100 and within the rectangular portion 160.

FIG. 2B shows an embodiment implemented on a mobile computing device 10 such as a mobile phone or tablet. The computing device 10 comprises a screen 20 having a circular portion 100 and a rectangular portion 160. A user may provide input to the computing device 10 via any suitable instrument, for example a touch device 210.

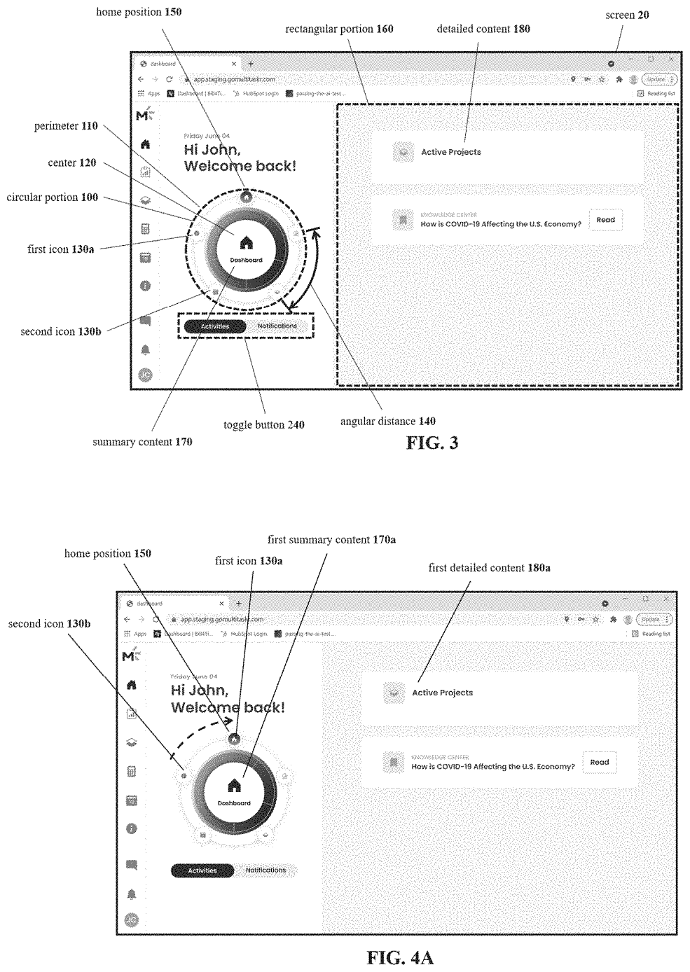

FIG. 3 shows a screen 20 comprising a circular portion 100 and a rectangular portion 160. The circular portion 100 is bounded by a substantially circular perimeter 110 that may or may not be visible to the user. A plurality of icons 130 are displayed within and adjacent to the perimeter 110. The plurality of icons 130 form a ring near and concentric to the perimeter 110, such that each first icon 130a is separated by an angular distance 140 from a neighboring second icon 130b. A home position 150 is defined along the ring of icons 130, for example in the twelve o'clock position as shown in FIG. 3. When an icon 130 is located at the home position, corresponding summary content 170 is displayed at a center 120 of the circular portion 100 and corresponding detailed content 180 is displayed in the rectangular portion 160.

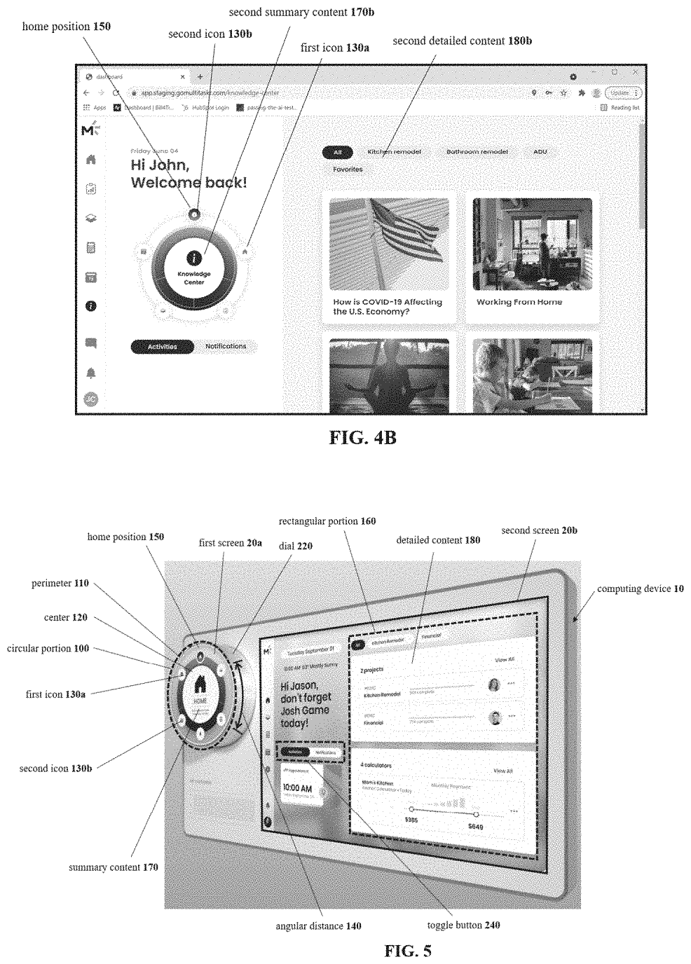

FIG. 4A shows a first icon 130a located at the home position 150. First summary content 170a corresponding to the first icon 130a is displayed at the center 120, and first detailed content 180a also corresponding to the first icon 130a is displayed in the rectangular portion 160. The curved dashed arrow in FIG. 4A indicates an exemplary revolution of the icons 130 within the circular portion 100 that revolves the second icon 130b into the home position 150 as shown in FIG. 4B. Such locating of the second icon 130b at the home position 150 selects the second icon 130b, which causes second summary content 170b corresponding to the second icon 130b to be displayed at the center 120 and second detailed content 180b corresponding to the second icon 130b to be displayed in the rectangular portion 160.

In the embodiments shown in FIGS. 2-4, the circular portion 100 and the rectangular portion 160 are portions of a same screen 20. A user may select an icon, for example the second icon 130b, by touching the screen 20 with a touch device 210 at the location of the second icon 130b or by moving a mouse cursor to such location. In some embodiments, when the second icon 130b is not located at the home position 150, the computing device 10 will automatically cause the icons 130 to revolve in unison about the center 120 until the second icon 130b is located at the home position 150. Such revolution may be in any suitable direction, for example: always clockwise; always counterclockwise; or in a direction corresponding to the shortest angular distance between the second icon 130b and the home position 150. Such automatic revolving of the icons 130 to place the second icon 130b at the home position 150 is an implementation of a “snap” feature. The snap feature may include an elastic feature where the second icon 130b may overshoot the home position 150 and then return to the home position 150 elastically, with or without additional diminishing overshoots as the second icon 130b settles to the home position 150.

In some embodiments the user may touch the screen 20 at or near an icon, for example a first icon 130a (or position a mouse cursor at or near the first icon 130a and click a mouse button) and then drag the first icon 130a along an arcuate path to the home position 150 in a manner similar to a rotary dialer on a rotary telephone. Such action causes the first icon 130a to be selected. In some embodiments the user may touch the screen 20 at or near the first icon 130a (or position a mouse cursor at or near the first icon 130a and click a mouse button) and then drag the first icon 130a by a predetermined distance along an arcuate path such that a second icon 130b becomes located at the home position 150. Such action causes the second icon 130b to be selected (rather than the first icon 130a). In some embodiments, the appearance of a cursor 202 may be altered when it is located at or near an icon 130 (or located at or near the perimeter of the circular portion 100) to indicate to a user that selection is possible. For example, the cursor 202 may appear as an arrow when it is not located at or near any icon 130, and it may appear as a hand when it is located at or near an icon 130. Additionally, the appearance of the cursor 202 may be further altered when a user performs a click-and-drag or touch-and-drag operation. For example, during a click-and-drag or touch-and-drag operation the cursor 202 may change from an open hand to a closed fist.

The computing device 10 may alter an appearance of a selected icon 130 immediately after it has been selected or after a delay, for example, after the selected icon 130 has revolved to the home position 150. The altered appearance may include a change in color, size, and/or shape of the selected icon 130 or of a region surrounding the selected icon 130 (e.g., a glow or highlight effect).

In some embodiments, after an icon 130 has been selected, summary content 170 is displayed at the center 120 of the circular portion 100 and detailed content 180 is displayed in the rectangular portion 160. The summary content 170 may be an enlarged or stylized version of the selected icon 130, or it may be some salient data taken or determined from the detailed content 180 or from elsewhere. For example, an icon that resembles a dollar sign “$” may represent a financial dashboard that a user can explore via the computing device 10. When the user selects such a “$” icon 130, the summary content 170 may consist of the user's numerical credit score (e.g., a single number) and the detailed content 180 may comprise information detailing the user's mortgage payments, credit history, monthly income, running project costs, and so on. The user may interact with the detailed content 180 via any suitable means, for example touching the rectangular portion 160 of the screen 120 at certain locations with a touch device 210.

FIG. 5 shows an embodiment of a system and method for displaying dashboard content that is loosely modelled after an early television as shown in FIG. 1. The embodiment comprises a computing device 10, such as a computer or laptop, having a first screen 20a capable of displaying a graphical user interface and a second screen 20b capable of displaying a graphical user interface. The first screen 20a is disposed within a perimeter 110 of a dial 220 and comprises a circular portion 100. The first screen 20a may be fixed to the dial 220 and therefore rotate in unison with the dial 220, or the first screen 20 may be fixed to a chassis of the computing device 10 and remain stationary when the dial 220 rotates. The second screen 20b is adjacent to the dial 220 and comprises a rectangular portion 160. A user may provide input to the computing device 10 via any suitable instrument as previously described, for example via touch device 210. For example, a user may contact the first screen 20a and/or the second screen 20b with a touch device 210. However, a user may also provide input to the computing device by physically rotating the dial 220.

When a user rotates the dial 220, the computing device 10 may cause the icons 130 to revolve in unison about the center 120 of the circular portion 100 until the selected icon 130 is located at a home position 150. The revolution of icons 130 may equal the angular speed of the dial 220, or the revolution of icons 130 may be greater or less than the angular speed of the dial 220, and such speed may be configurable by a user in some embodiments. An icon 130 may snap to (or from) the home position as rotation of the dial 220 causes that icon 130 to revolve towards (or away) from the home position 150.

The exemplary embodiments of FIGS. 2-5 show five icons 130 in the circular portion 100. However, there may be more or fewer icons 130 displayed in the circular portion 100, and the appearance of the icons 130 may differ from those shown. Factors that may affect the number and appearance of icons 130 may include: (1) a specific mode of operation of the computing device 10, for example a free versus paid mode or a basic versus advanced mode; (2) a specific project for which the computing device 10 presents content, for example a dwelling renovation project versus a new construction project, an interior renovation versus an exterior renovation, an attached addition versus a detached addition, or a primary residence improvement versus an accessory dwelling unit construction; and (3) a specific user interacting with the computing device 10, for example a guest versus a power user versus an administrator. The computing device 10 may comprise hardware and/or software capable of detecting and/or determining which factors may apply. For example, the computing device 10 may include: (1) a camera capable of capturing an image of a user's face and software capable of performing facial recognition; (2) a microphone capable of capturing audio of a user's voice and software capable of performing word recognition and/or voice recognition; and/or (3) a display capable of presenting a user-authentication challenge and a hard or soft keyboard or number pad capable of accepting alphanumeric input.

Content represented by the icons 130 and displayed by the computing device 10 may include: a dwelling analysis report comprising property information and suggested upgrades to the property; a status of any existing or future dwelling renovation or construction projects for the property; a project exploration and configuration tool and/or calculator; a project benefit and/or cost analysis; a customer's financial report; project scheduling information; a feed of curated articles and blog entries matching the customer's current or future projects or project interests; a communications portal between the property owner and select contractors and/or service providers; and a project archive comprising information related to timelines, phases, milestones, deliverables, and reports.

The computing device 10 may display a toggle button 240 that enables a user to toggle between displaying activities and notifications. An example of an activity may be a scheduled visit by a contractor or service provider to capture aerial images and lidar scans of a subject property, whereas an example of a notification may be a reminder that a contractor or service provider will be visiting the property in one hour. Notifications may comprise emails, text messages, images, voice recordings, videos, or any other suitable communication formats. The toggle button 240 may be displayed adjacent to the circular portion 100, for example below the circular portion 100 as shown in FIG. 3, or adjacent to the rectangular portion 160, for example beside the rectangular portion 160 as shown in FIG. 5. Notifications and/or activities may be displayed within the rectangular portion 160, as shown in FIG. 2B, or they may be displayed adjacent to the rectangular portion 160 as shown in FIG. 5.

In some embodiments, when the toggle button 240 is toggled to “activities,” the rectangular portion 160 may highlight or exclusively display any activities, and when the toggle button 240 is toggled to “notifications,” the rectangular portion 160 may highlight or exclusively display any notifications.

In some embodiments, the icons 130 displayed in the circular portion 100 may be redundantly displayed at another location outside the circular portion 100, for example adjacent thereto. FIG. 3 shows icons 130 redundantly displayed in a vertical column to the left of the circular portion 100, whereas FIG. 5 shows icons 130 redundantly displayed in a vertical column between the circular portion 100 the rectangular portion 160. When a user selects a redundantly displayed icon 130, the corresponding icon 130 that is displayed within the circular portion may indicate such selection by exhibiting an altered appearance and/or being automatically revolved to a home position as described earlier.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A method for displaying content by a computing device, the method comprising:
displaying, adjacent to and within a perimeter of a circular portion of a display screen of the computing device, a plurality of icons each separated by an angular distance;
receiving a user selection of a first icon;
displaying, near a center of the circular portion, first summary content related to the first icon in response to receiving the user selection of the first icon;
displaying, within a rectangular portion of the display screen, first detailed content related to the first icon in response to receiving the user selection of the first icon;
receiving a user selection of a second icon;
displaying, near the center of the circular portion, second summary content related to the second icon in response to receiving the user selection of the second icon; and
displaying, within the rectangular portion, second detailed content related to the second icon in response to receiving the user selection of the second icon.

2. The method of claim 1 wherein the circular portion and the rectangular portion are portions of a same first screen.

3. The method of claim 2 wherein at least one of receiving the user selection of the first icon or receiving the user selection of the second icon comprises at least one of:
receiving an input indicative of a mouse being moved to locate a cursor at or near the respective icon and a button of the mouse being clicked;
receiving an input indicative of the mouse being moved to locate the cursor at or near the respective icon, receiving a click of a button of the mouse, and receiving an input indicative of a dragging of the respective icon by a predetermined distance or to a predetermined location;
receiving an input indicative of a touching of the first screen at or near the respective icon with a finger or stylus; or
receiving an input indicative of a touching of the first screen at or near the respective icon with a finger or stylus and dragging the respective icon by a predetermined distance or to a predetermined location.

4. The method of claim 1 wherein selecting an icon causes the plurality of icons to revolve about the center of the circular portion until the icon revolves to a home position.

5. The method of claim 4 wherein the home position corresponds to a twelve o'clock position of the circular portion.

6. The method of claim 1 wherein selecting an icon alters an appearance of the icon, the appearance comprising at least one of: a color, a size, or a shape.

7. The method of claim 1 wherein the circular portion is a portion of a first screen disposed concentrically within a physically rotatable dial and the rectangular portion is a portion of a second screen adjacent to the dial.

8. The method of claim 7 wherein rotating the dial causes the plurality of icons to revolve about the center of the circular portion codirectionally with the dial.

9. The method of claim 8 wherein at least one of receiving the user selection of the first icon or receiving the user selection of the second icon comprises receiving an input causing the dial to rotate until the respective icon is located at or near a home position.

10. The method of claim 9 wherein the home position corresponds to a twelve o'clock position on the circular portion.

11. A non-transitory computer-readable medium comprising instructions for causing a computing device to perform a method for displaying content, the method comprising:
displaying, adjacent to and within a perimeter of a circular portion of a display screen of the computing device, a plurality of icons each separated by an angular distance;
receiving a user selection of a first icon;
displaying, near a center of the circular portion, first summary content related to the first icon in response to receiving the user selection of the first icon;
displaying, within a rectangular portion of the display screen, first detailed content related to the first icon in response to receiving the user selection of the first icon;
receiving a user selection of a second icon;
displaying, near the center of the circular portion, second summary content related to the second icon in response to receiving the user selection of the second icon; and
displaying, within the rectangular portion, second detailed content related to the second icon in response to receiving the user selection of the second icon.

12. The medium of claim 11 wherein the circular portion and the rectangular portion are portions of a same first screen.

13. The medium of claim 12 wherein at least one of receiving the user selection of the first icon or receiving the user selection of the second icon comprises at least one of:
receiving an input indicative of a mouse being moved to locate a cursor at or near the icon and a button of the mouse being clicked;
receiving an input indicative of the mouse being moved to locate the cursor at or near the icon, receiving a click of a button of the mouse, and receiving an input indicative of a dragging of the icon by a predetermined distance or to a predetermined location;
receiving an input indicative of a touching of the first screen at or near the icon with a finger or stylus; or
receiving an input indicative of a touching of the first screen at or near the icon with a finger or stylus and dragging the icon by a predetermined distance or to a predetermined location.

14. The medium of claim 11 wherein selecting an icon causes the plurality of icons to revolve about the center of the circular portion until the icon revolves to a home position.

15. The medium of claim 14 wherein the home position corresponds to a twelve o'clock position of the circular portion.

16. The medium of claim 11 wherein selecting an icon alters an appearance of the icon, the appearance comprising at least one of: a color, a size, or a shape.

17. The medium of claim 11 wherein the circular portion is a portion of a first screen disposed concentrically within a rotatable dial and the rectangular portion is a portion of a second screen adjacent to the dial.

18. The medium of claim 17 wherein rotating the dial causes the plurality of icons to revolve about the center of the circular portion codirectional with the dial.

19. The medium of claim 18 wherein at least one of receiving the user selection of the first icon or receiving the user selection of the second icon comprises receiving an input causing the dial to rotate until the respective icon is located at or near a home position.

20. The medium of claim 19 wherein the home position corresponds to a twelve o'clock position on the dial.
